(19) United States
(12) Patent Application Publication
(10) Pub. No.: US 2007/0286938 A1
(43) Pub. Date: Dec. 13, 2007

(54) Process For Producing Enzyme-Treated Tea Extract, Enzyme-Treated Natural Tea Aroma And Enzyme-Treated Natural Tea Aroma Concentrated Extract, And Enzyme-Treated Tea Extract, Enzyme-Treated Natural Tea Aroma And Enzyme-Treated Natural Tea Aroma Concentrated Extract Thereby Obtained

(75) Inventors: Kenji Saiki, Kanagawa (JP); Tadahiro Hiramoto, Kanagawa (JP); Satoshi Masumura, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Ineos Europe Limited, Lyndhurst (GB)

(21) Appl. No.: 11/667,486

(22) PCT Filed: Dec. 7, 2005
(86) PCT No.: PCT/JP05/22473

§ 371 Date: May 10, 2007

(30) Foreign Application Priority Data
Dec. 8, 2004 (JP) 2004-354967

(51) Int. Cl. A23F 3/16; A23F 3/40

(52) U.S. Cl. 426/597

(57) ABSTRACT

The present invention relates to a process for producing an enzyme-treated tea extract, which comprises allowing at least one selected from an enzyme and/or a group of enzymes capable of producing a green aroma compound to act on a tea extract, a tea slurry and/or a tea leaf; and a process for producing an enzyme-treated natural tea aroma and an enzyme-treated natural tea aroma concentrated extract, which further comprises collecting a tea aroma from the enzyme-treated tea extract.

### TECHNICAL FIELD

The present invention relates to a process for producing an enzyme-treated tea extract, an enzyme-treated natural tea aroma and an enzyme-treated natural tea aroma concentrated extract from a tea extract, a tea slurry and/or a tea leaf. Further, it relates to an enzyme-treated tea extract, an enzyme-treated natural tea aroma and an enzyme-treated natural tea aroma concentrated extract obtainable by the process. Still further, it relates to foods and drinks containing the enzyme-treated tea extract, the enzyme-treated natural tea aroma and the enzyme-treated natural tea aroma concentrated extract.

### BACKGROUND ART

Extract and aroma of teas such as green tea, black tea and oolong tea have been so far widely used in foods, drinks, confectionery, luxuries (for example, alcoholic drinks) and the like. The tea extract and the tea aroma are roughly divided into natural products and synthetic products depending on the raw materials thereof. In recent years, intention to health and safety to the body have attracted much interest, and attention has been drawn to environments. Accordingly, the use of natural extract and natural-derived aroma has been increasingly demanded.

According to the invention, unless otherwise instructed, “tea aroma” refers to gas, liquid or solid having aroma of teas regardless of the synthetic product or the natural product. In addition, the term “natural” refers to a so-called natural product without treatment with chemical substances and without addition of chemical substances.

Tea extracts and natural tea aroma as natural products are prepared from buds and leaves of a tea plant of the family Theaceae usually by hot-water extraction.

The quality and the intensity of aroma of the tea extract and the natural tea aroma depend on a period in which tea leaves as the raw materials are plucked, and the like. Generally, tea which enjoys evaluation of so-called good aroma with a good quality and a high intensity is deemed to be high-grade tea and is expensive. Meanwhile, tea having a bad quality and a low intensity of aroma is deemed to be low-grade tea and is less expensive.

However, tea extracts or natural tea aroma obtainable by hot-water extraction are problematic in that the aroma inherent in tea leaves is lost due to the hot water and the intensity of aroma is decreased. The aroma of teas is composed of many components. Among these, green aroma compounds such as (Z)-3-hexenol (cis-3-hexenol) are especially important as the components that give a green feel of teas, especially a fresh feel of teas. In addition floral aroma compounds such as geraniol are especially important as the components that give a floral feel. Characteristic aroma inherent in teas can be provided by a well-balanced combination of these components. However, green aroma compounds such as (Z)-3-hexenol (cis-3-hexenol) are liable to be lost by heating in an extraction or collecting procedure because these compounds contain a large amount of low-boiling components and are easy to denature. Consequently, the loss thereof is great during production, and therefore, serious influence has been given to the intensity and the quality of aroma. Accordingly, for obtaining tea extract and natural tea aroma having better aroma and a satisfactory intensity of aroma, it is necessary to use high-quality tea leaves having an excellent quality of aroma and a strong intensity of aroma. As a result, the cost for production of the resulting tea extract and natural tea aroma has been high. Therefore, a method for obtaining tea extract and natural tea aroma having aroma inherent in tea leaves and a strong intensity of the aroma has been highly demanded. A large number of methods for obtaining tea extracts with a stronger intensity of aroma have been so far proposed.

For example, Patent Document 1 (JP-A-2000-342179) discloses that tea drink having fine aroma provided by fresh-drawn tea is obtained by adding a trace amount of 4-mercapto-4-methyl-2-pentanone to the tea drink. However, according to this method, although an intensity of aroma is increased, aroma of natural teas has not yet been reproduced. Moreover, in recent years, the use of extract and aroma derived from natural substances has been required. Patent Document 2 (JP-A-2001-286260) proposes a process in which tea or tea extract is subjected to a reaction with a hydrolydase such as β-glucosidase, cellulase, glycosidase or oligoglycosidase to enhance the intensity of aroma, Patent Document 3 (pamphlet of WO 00/18931) proposes a process in which tea or tea extract is subjected to a reaction with primeverosidase to enhance the intensity of aroma, and Patent Document 4 (JP-A-4-228028) proposes a process in which tea extract residue is hydrolyzed with cellulase to produce water-soluble tea extract having a tea flavor. Although specific aroma components are increased in these processes, balance of aroma of tea is rather extremely lost. Accordingly, they have been unsatisfactory in view of increasing well-balanced aroma inherent in tea. Patent Document 5 (JP-A-2003-144049) discloses a process in which tea extract with an umami or a mouthfulness and a less astringent taste is produced by reacting teas with two types of enzymes which is protease and tannase. Although some effects are observed in view of the increase in umami and the prevention of turbidity, the process has not been satisfactory enough in view of increasing the intensity of aroma.

For increasing the intensity of aroma of tea extract, other various approaches have been made, and a method for collecting tea aroma or extract by controlling a heating temperature or time, and the like have been proposed. However, tea extract, natural tea aroma and natural tea aroma concentrated extract that reproduce aroma of natural teas, especially freshness of teas have not yet been obtained.

### DISCLOSURE OF THE INVENTION

### Problems that the Invention is to Solve

It is an object of the invention to provide a process for producing tea extract, natural tea aroma and natural tea aroma concentrated extract having aroma equal to or closer to that which is inherent in teas is and also increased aroma intensity, even by using inexpensive tea leaves as the raw materials.

Another object of the invention is to provide a process for producing tea extract, natural tea aroma and natural tea aroma concentrated extract which are safe and eco-friendly. Still another object of the invention is to provide tea extract, natural tea aroma and natural tea aroma concentrated extract which are obtainable by the above process and are less costly and economically advantageous. In addition, still another object of the invention is to provide food or drink containing the same.

### Means for Solving the Problems

Conventionally, processes for producing tea extract and tea aroma using an enzyme provides some effect for increasing the intensity of aroma, but the balance of the composition of aroma components is bad, and aroma of teas has not been satisfactorily provided. Accordingly, the present inventors have made intensive studies, and consequently found that the above objects can be achieved by reacting low-grade tea leaves or tea extract or tea slurry obtainable from the low-grade tea leaves as the raw materials with a specific enzyme, thereby completing the invention.

Namely, the invention is as mentioned below.

(1) A process for producing an enzyme-treated tea extract, which comprises allowing at least one selected from an enzyme and/or a group of enzymes capable of producing a green aroma compound to act on a tea extract, a tea slurry and/or a tea leaf.

(2) The process for producing an enzyme-treated tea extract according to claim 1, wherein the enzyme and/or the group of enzymes capable of producing the green aroma compound is crude enzymes derived from soybean.

(3) A process for producing an enzyme-treated natural tea aroma and an enzyme-treated natural tea aroma concentrated extract, which comprises collecting a tea aroma from the enzyme-treated tea extract obtainable by the process according to (1) or (2).

(4) The process for producing an enzyme-treated natural tea aroma and an enzyme-treated natural tea aroma concentrated extract according to (3), wherein the tea aroma is collected by a gas-liquid countercurrent contact extraction method or an extraction method with carbon dioxide in a liquid state or a supercritical state.

(5) An enzyme-treated tea extract which is produced by the process according to (1) or (2).

(6) An enzyme-treated natural tea aroma which is produced by the process according to (3) or (4).

(7) An enzyme-treated natural tea aroma concentrated extract which is produced by the process according to (3) or (4).

(8) A food or drink comprising the enzyme-treated tea extract according to (5).

(9) A food or drink comprising the enzyme-treated natural tea aroma according to (6).

(10) A food or drink comprising the enzyme-treated natural tea aroma concentrated extract according to (7).

### Advantage of the Invention

According to the invention, a process for producing tea extract, natural tea aroma and natural tea aroma concentrated extract having well-balanced tea aroma and a high intensity of aroma without treatment with chemical substances, and tea extract, natural tea aroma and natural tea aroma concentrated extract which are obtainable by the process can be provided.

In addition, tea extract, natural tea aroma and natural tea aroma concentrated extract with a high-grade feel can be produced even by using inexspensive tea leaves as the raw materials.

### BEST MODE FOR CARRYING OUT THE INVENTION

The invention is described below in detail.

In this specification, all parts, percentages, ratios and the like defined by mass are the same with those by weight, respectively.

Tea leaves as the raw materials of the tea extract or the tea slurry used in the invention, group of enzymes used, preparation of the tea extract, enzyme treatment steps, the method for collecting natural tea aroma from tea extract and slurry and the process for producing natural tea aroma concentrated extract are described in detail below.

Regarding the teas as the raw materials in the invention, teas obtained from buds and leaves of tea plant of the family Theaceae (scientific name Camellia sinensis) can be employed without limitation. Teas include Chinese species (Camelia sinensis var sinensis), Assam species (Camellia sinensis var assamica), Cambodian species (Camellia sinensis var ssp. lasiocalyx) and the like. Any of them can be used in the invention.

Specific examples thereof include unfermented teas (Sen-cha, Kabuse-cha, Gyokuro, Tencha, Mat-cha, Tamaryoku-cha, ban-cha, hoji-cha, kamairi-cha and the like), semi-fermented teas (hoshucha, Tekkannon-cha, Oolong tea and the like), and fermented teas (black tea, Awa-bancha, Goishi-cha, Toyama-kurocha, Sen-cha, Puer tea and the like). A blend of blending several types of the foregoing teas in appropriate proportions may be used.

High-grade tea in the invention mean those estimated to have so-called good aroma with a good quality and a high intensity of aroma, which are usually referred as the first harvested tea and the second harvested tea. Meanwhile, low-grade tea mean those estimated to have so-called poor aroma with a bad quality and a low intensity of aroma, which are usually referred as the third harvested tea and the fourth harvested tea. Regarding the first to fourth harvested teas referred herein, for example, in case of Japanese green tea, the first harvested tea mean those harvested from late March to late May, the second harvested tea mean those harvested from the middle in May to the middle in July, the third harvested tea mean those harvested from late June to the middle in September, and the fourth harvested tea mean those harvested from late July to late October.

In the process for producing tea extract in the invention, it is advisable to extract the tea leaves by usual methods. Examples thereof include a process in which tea leaves are charged into an extraction vessel and immersed in a predetermined amount of water for a prescribed period of time and then tea grounds are removed to obtain the extract, a process in which tea leaves are charged into an extraction tank and water at a prescribed flow rate is then fed to obtain a predetermined amount of extract, and the like.

Examples of water used in the extraction include tap water, ion-exchanged water, distilled water, natural water, natural mineral water, degassed water, ascorbic acid-containing water, water with pH adjustment (including a buffer solution) and the like.

Amount of water used in the extraction is not particularly limited so long as the tea leaves are fully immersed in the water. Usually, the amount of water is preferably at least 5 times, more preferably from 10 to 50 times, still more preferably from 10 to 25 times the amount of the tea leaves used.

A temperature of water used in the extraction is not particularly limited so long as the extraction can be conducted, and is usually from 4 to 95° C. and especially preferably from 30 to 90° C.

An extraction time is not particularly limited either, and is usually from 1 minute to 12 hours and especially preferably from 5 minutes to 6 hours.

In the invention, tea slurry other than tea extract may be used. The term, “tea slurry” here referred to means slurry obtainable by milling tea leaves to an appropriate size and adding a predetermined amount of water thereto. Types of water, amount of water, temperature of water and the like are same as those in the tea extract.

Specific examples of the green aroma compound in the invention include (Z)-3-hexenol (cis-3-hexenol), (Z)-3-hexenal (cis-3-hexenal), (E)-3-hexenol (trans-3-hexenol), (E)-3-hexenal (trans-3-hexenal), (E)-2-hexenol (trans-2-hexenol), (E)-2-hexenal (trans-2-hexenal), hexanol, hexanal, (Z,Z)-3,6-nonadienol (cis,cis-3,6-nonadienol), (Z,Z)-3,6-nonadienal (cis,cis-3,6-nonadienal), (E,Z)-2,6-nonadienol (trans,cis-2,6-nonadienol), (E,Z)-2,6-nonadienal (trans,cis-2,6-nonadienal), (Z)-3-nonenol (cis-3-nonenol), (Z)-3-nonenal (cis-3-nonenal), (E)-2-nonenol (trans-2-nonenol), (E)-2-nonenal (trans-2-nonenal) and the like compounds by which a green feel of teas, especially freshness of teas is given to the sense of smell of humans. Among these green aroma compounds, (Z)-3-hexenol (cis-3-hexenol) and hexanol are especially referred as the important examples.

According to the invention, the enzymes and/or the groups of enzymes capable of producing the green aroma compound are not particularly limited so long as they can produce the above-mentioned green aroma compounds. Examples thereof include enzymes or groups of enzymes producing a C6 compound (carbon number 6: (Z)-3-hexenol (cis-3-hexenol), (E)-2-hexenal (trans-2-hexenal) and the like) or C9 compound (carbon number 9: (E,Z)-2,6-nonadienal (trans,cis-2,6-nonadienal), (E)-2-nonenal (trans-2-nonenal) and the like) described in Kagaku to Seibutsu, vol. 31, No. 12, 826-834, 1993. Preferable examples of the enzyme include lypolytic acyl hydrolase, O₂ addition enzyme (lipoxygenase), hydroperoxidelyase, alcohol dehydrogenase and enzyme containing isomerization factor, and the groups of enzymes containing multiple enzymes above are more preferable.

In the invention, crude enzymes derived from plants such as melon, cucumber, soybean, wheat, kidney bean and alfalfa can be used. Among these, a crude enzyme using defatted soybean cake is preferably used because it can easily be obtained at low cost. In this regard, defatted soybean cake means a crushed matter of cake which is obtainable as a by-product in the course of milling plant oil from soybeans according to the usual methods.

Tea extract or tea slurry treated with the enzyme and/or the group of enzymes producing the green aroma compound can be obtained by conducting a heat treatment (for example, at 80° C. for 10 minutes) to deactivate the enzyme.

The enzyme-treated tea extract in the invention is obtainable by the treatment with the enzyme and/or the group of enzymes producing the green aroma compound. It may further be treated with an enzyme producing a floral aroma compound, such as hydroxynitrilelyase, esterase, glucosidase, primeverosidase, ester synthetase, lactone synthetase, xanthine oxidase, hydroxylase, decarboxylase or alcohol dehydrogenase or crude enzymes containing the same; lipase which is a lipolytic enzyme, protease which decomposes a protein into amino acids, cellulase which decomposes cell walls, tannase which decomposes tannin, pectinase which decomposes pectin, protopectinase which decomposes protopectin adhering cells, phospholipase which decomposes phospholipid constituting a biomembrane, glucosidase or oligoglycosidase, or crude enzymes containing the same. The enzyme and/or the group of enzymes producing the green aroma compound may be used in combination with other enzymes or crude enzymes containing the same for an enzyme treatment in order to obtain tea extract or tea aroma having various qualities of aroma, to increase the extraction efficiency of the aroma compounds, to increase a mouthfulness or an umami and to inhibit occurrence of precipitation or turbidity.

As the enzymes and/or the groups of enzymes, those derived from plants, bacteria and animals can be used.

Especially, in the point of enhancing the aroma intensity in a balanced manner, it is especially preferable to carry out an enzyme treatment by using the enzyme and/or the group of enzymes producing the green aroma compound and the enzyme and/or the group of enzymes producing a floral aroma compound in combination.

According to the invention, specific examples of the floral aroma compound include geraniol, nerol, linalool, (E)-nerolidol (trans-nerolidol), benzyl alcohol, β-phenylethyl alcohol, (Z)-linalool-3,6-oxide (cis-linalool-3,6-oxide), (E)-linalool-3,6-oxide (trans-linalool-3,6-oxide), (Z)-linalool-3,7-oxide (cis-linalool-3,7-oxide), (E)-linalool-3,7-oxide (trans-linalool-3,7-oxide), benzaldehyde, β-damascone, α-ionone, β-ionone, (Z)-jasmone (cis-jasmone), methyl jasmonate and the like compounds by which a floral feel of teas, especially a luxurious feel of teas is given to the sense of smell of humans.

When the tea leaves, the tea extract or the tea slurry is treated with a combination of at least one selected from the enzyme and/or the group of enzymes producing the green aroma compound, and an enzyme producing the floral aroma compound and/or another enzyme such as lipase, protease, cellulase or tannase, the treatment may be conducted simultaneously or consecutively. Or the leaves, the tea extract or the tea slurry may be mixed after the treatment with each enzyme.

The ratio of each enzyme used can properly be changed depending on the types of teas as the raw materials. It can also be adjusted according to the desired tea aroma.

In the case of the enzyme producing the green aroma compound, for example, in the case of defatted soybean cake, although it depends on the enzyme activity of the defatted soybean cake, the addition amount is from 0.001 to 20% by mass, preferably from 0.01 to 15% by mass based on the tea extract or the tea slurry used, as a defatted soybean cake-treated solution. In this case, it is preferable to use defatted soybean cake having an enzyme activity of from 10 to 100,000 units/mg, preferably from 100 to 100,000 units/mg as a lypoxygenase.

Here, 1 unit means an amount of an enzyme which is required to increase the absorbance at 234 nm by 0.001 for 1 minute upon acting on 1 μmol of a substrate (linoleic acid).

A reaction temperature in the enzyme treatment step is preferably from 4 to 50° C., more preferably from 15 to 40° C., still more preferably from 20 to 35° C. A reaction time is preferably from 0.5 to 48 hours, more preferably from 15 to 42 hours, still more preferably 25 to 42 hours.

Herein, as the example of the defatted soybean cake-treated solution, a supernatant obtainable by adding an buffer solution and stirring thereof (hereinafter, referred as “treatment”) followed by subsequent conducting centrifugation may be used. In this regard, according to the present invention, the defatted soybean cake-treated solution is not limited to that obtainable by the above treatment, and it is also possible to use, for example, a defatted soybean cake-treated solution obtainable by a variety of chromatography and the like. In the course of preparing defatted soybean cake-treated solution, the concentration of the defatted soybean cake after the addition of buffer solution is preferably from 1 to 20% by mass, especially preferably from 5 to 20% by mass. The buffer solution to be added preferably has a concentration in the range of 0.01 to 0.5 M and a pH in the range of 6 to 8. Further, phosphate buffer solution and tris-hydrochloric acid buffer solution may be mentioned as preferable examples of the buffer solution. The treatment temperature is preferably from 0 to 10° C., more preferably from 0 to 4° C. The treating time is preferably from 0.5 to 12 hours, more preferably from 1 to 6 hours.

In the case of the enzyme and/or the group of enzymes producing the floral aroma compound, for example, in the case of β-glycosidase, the enzyme addition amount is preferably from 0.001 to 1% by mass, more preferably from 0.01 to 0.5% by mass, still more preferably from 0.01 to 0.1% by mass based on the tea extract or the tea slurry used. A reaction temperature is preferably from 4 to 65° C., more preferably from 25 to 60° C., still more preferably from 40 to 55° C. A reaction time is preferably from 0.5 to 48 hours, more preferably from 1 to 24 hours, still more preferably from 2 to 4 hours.

In the case of lipase, the enzyme addition amount is preferably from 0.001 to 1% by mass, more preferably from 0.005 to 0.5% by mass based on the tea extract or the tea slurry used. A reaction temperature is preferably from 20 to 60° C., more preferably from 30 to 50° C.

A reaction time is preferably from 1 to 48 hours.

In the case of protease, the enzyme addition amount is preferably from 0.01 to 5% by mass, more preferably from 0.05 to 2% by mass based on the tea extract or the tea slurry used. A reaction temperature is preferably from 20 to 65° C., more preferably from 40 to 55° C. A reaction time is preferably up to 48 hours.

In the case of cellulase, the enzyme addition amount is preferably from 0.02 to 2% by mass, more preferably from 0.1 to 0.2% by mass based on the tea extract or the tea slurry used. A reaction temperature is preferably from 20 to 65° C., more preferably from 40 to 55° C. A reaction time is preferably from 2 to 48 hours.

In the case of tannase, the enzyme addition amount is preferably from 0.001 to 1% by mass, more preferably from 0.01 to 0.5% by mass based on the tea extract or the tea slurry used. A reaction temperature is preferably from 20 to 60° C., more preferably from 25 to 50° C.

A reaction time is preferably from 0.5 to 24 hours.

The enzyme-treated tea extract here may further be blended with a combination of other extracts at an appropriate ratio, such as an unpolished rice extract, a wheat extract, an evening primrose extract, a loquat leaf extract, a senna tea extract, a nannban millet extract, an adlay extract, a dokudami extract, a chicory extract, an ashitaba extract, a guava leaf extract, a persimmon leaf extract, a kumazasa extract, a black soybean extract, a kombu extract, a reishi extract, a sesame extract, a safflower extract, an orange peel extract and the like.

Preparation of Enzyme-Treated Natural Tea Aroma

In another embodiment of the invention, enzyme-treated natural tea aroma is prepared by means of collecting aroma compounds from the enzyme-treated tea extract prepared by treating the tea extract or the tea slurry with the enzyme.

As the means of collecting aroma compounds used to prepare the enzyme-treated natural tea aroma, conventional methods used in distillation, extraction and immersion may be employed.

Examples of the distillation include distillation and rectification, and a distillation column is used as a device. As the distillation methods, atmospheric distillation, distillation under reduced pressure, vacuum distillation, pressure distillation, steam distillation, carbon dioxide gas distillation, molecular distillation, dry distillation, azeotropic distillation, extraction distillation and the like are mentioned. The distillation may be conducted batchwise, continuously or semi-continuously.

Examples of the extraction and immersion methods include the cold immersion method, the hot immersion method, the batchwise extraction method, the multi-stage extraction method, the multiple extraction method, the countercurrent multi-stage extraction method, the countercurrent continuous extraction method, the continuous differential extraction method, gas-liquid extraction, liquid carbon dioxide extraction, supercritical fluid extraction and the like. These methods may be used in combination.

In the invention, since the aroma compounds enhanced in the tea extract or the tea slurry during the enzyme treatment step can be collected in the concentrated state under such conditions that the heating time is as short as possible and the heating temperature is as low as possible, it is preferable to collecting aroma using a gas-liquid countercurrent contact extraction method (Spinning Cone Column: SCC), which is a kind of a thin film steam distillation device, or an extraction method with carbon dioxide in a liquid state or a supercritical state (for example, supercritical carbon dioxide extraction method and the like), and the gas-liquid countercurrent contact extraction method (SCC) is especially preferable. Regarding the application of SCC, conventional methods may be mentioned, and are described in, for example, JP-A-9-308455, JP-A-2002-105485, JP-A-2002-105486 and JP-A 2002-142713. Further, regarding the application of the extraction method with carbon dioxide in a liquid state or a supercritical state, conventional methods may also be mentioned, and are described in, for example, JP-A-6-133725.

The natural tea aroma as aroma compound can be separated and collected from the enzyme-treated tea extract or the enzyme-treated tea slurry preferably via the means of collecting aroma compounds with SCC or the extraction method with carbon dioxide in a liquid state or a supercritical state.

Furthermore, thus-collected enzyme-treated natural tea aroma and enzyme-treated tea extract residue are mixed at an appropriate ratio to obtain the enzyme-treated natural tea aroma concentrated extract containing the tea extract having an enhanced intensity of aroma. With respect to the enzyme-treated tea extract residue obtainable by the means of collecting aroma compound, it is preferable to use a product produced by usual treatment methods. For example, a method can be mentioned in which the enzyme-treated tea natural extract residue is filtered via a metallic screen, a cloth or the like to remove the tea leaves and fine filtration is optionally conducted by centrifugation, membrane filtration, auxiliary filtration or the like to remove insoluble matters. In this case, the enzyme-treated natural tea aroma concentrated extract having a higher intensity of aroma can be prepared by increasing the ratio of the enzyme-treated natural tea aroma. The mixing ratio depends on the intensity of the enzyme-treated natural tea aroma. For example, enzyme-treated natural tea aroma:enzyme-treated tea extract residue ratio may be 1:1 to 1:100 (by mass), preferably 1:10 to 1:100 (by mass).

In the invention, in the case of mixing the enzyme-treated natural tea aroma whose aroma compounds are collected from plural enzyme-treated tea extracts or slurries with SCC, the enzyme-treated natural tea aroma collected from the enzyme-treated tea extracts which have been solely treated respectively with SCC may be mixed; the enzyme-treated natural tea aroma may be collected with SCC after the enzyme-treated tea extracts solely treated respectively are mixed; or the enzyme-treated natural tea aroma may be collected from the enzyme-treated tea extract treated with plural enzymes at the same time with SCC.

The enzyme-treated tea extract, the enzyme-treated natural tea aroma and the enzyme-treated natural tea aroma concentrated extract obtainable by the process of the invention, or a flavor composition containing the enzyme-treated tea extract, the enzyme-treated natural tea aroma and the enzyme-treated natural tea aroma concentrated extract can be used in foods and drinks such as beverages, alcoholic drinks, cold confectionery and deserts, baked confectionery, tablet confectionery and gums. Specific examples thereof include drinks such as tea beverages (green tea, oolong tea, black tea, blended tea and the like), milk drinks, sports drinks, near water, nutrient drinks and carbonated drinks; alcoholic drinks such as low-malt beers and cocktails; cold confectionery and desserts such as custard puddings, Bavarian creams, jellies, yoghurts, sherbets and ice creams; baked confectionery such as cookies and biscuits; tablet confectionery such as candies and tablets; gums and the like.

The flavor composition containing the enzyme-treated tea extract, the enzyme-treated natural tea aroma or the enzyme-treated natural tea aroma concentrated extract of the invention can widely be applied to the field of fragrant cosmetics such as air freshener.

The above enzyme-treated tea extract, enzyme-treated natural tea aroma and enzyme-treated natural tea aroma concentrated extract or the flavor composition containing the enzyme-treated tea extract, the enzyme-treated natural tea aroma or the enzyme-treated natural tea aroma concentrated extract may contain various agents, for example, stabilizers (antioxidants) such as vitamin C and vitamin E, thickening agents such as dextrin, xanthane gum, lecithin and gelatin, various dyes, antibacterial agents such as benzoic acids, surfactants such as polyoxyethylene alkyl ether and fatty acid alkylolamide, pH adjustors such as sodium bicarbonate, citric acid and malic acid, sweeteners such as aspartame and sucrose, gum bases, nutritional enhancers such as vitamin A and calcium lactate. As the flavor in the flavor composition, there are a natural flavor and a synthetic flavor. Examples of the aroma type thereof include a citrus type, a fruit type, a milk type, a mint type, a spice type, a flower type, a tea type, a vanilla type, a savory type, a beans type and the like.

### EXAMPLES

Examples and Comparative Examples are described below. However, the invention is not limited to the following Examples.

### Example 1

### Preparation of a Group of Enzymes Producing a Green Aroma Compound

A supernatant obtained by adding 30 ml of a 20 mM phosphate buffer solution (pH 7.0) to 3.6 g of defatted soybean cake (using a product with an enzyme activity of 729 units/mg, manufactured by Sigma), stirring the mixture at 4° C. for 1 hour and conducting filtration was used as a defatted soybean cake-treated solution. As the defatted soybean cake, a product procured from Sigma was employed (trade name: SOYBEAN FLOUR TYPE I (not roasted)).

Preparation of a Tea Extract Treated with a Group of Enzymes Producing a Green Aroma Compound

To 15 g of green tea leaves (made in Japan, variety: Yabukita, low-grade product) pulverized with a cocking cutter, 135 ml of ion-exchanged water was added, and 15 ml of the above-obtained defatted soybean cake-treated solution was further added to conduct enzyme treatment in a thermostat at 4° C. for 12 hours. The tea leaves were then removed by filtration with a cloth. The resulting extract was heat-treated at 90° C. for 10 minutes to obtain a green tea extract treated with the group of enzymes producing the green aroma compound.

### Example 2

An enzyme-treated green tea extract was obtained in the same manner as in Example 1 except that the enzyme treatment temperature was changed from 4° C. to 25° C.

### Example 3

An enzyme-treated green tea extract was obtained in the same manner as in Example 1 except that the enzyme treatment temperature was changed from 4° C. to 40° C.

### Comparative Example 1

### Preparation of an Enzyme-Untreated Green Tea Extract

An enzyme-untreated green tea extract was obtained in the same manner as in Example 1 except that 15 ml of a 20 mM phosphate buffer solution (pH 7.0) was added instead of the defatted soybean cake-treated solution.

Organoleptic Evaluation (1)

With respect to the enzyme-treated green tea extracts in Examples 1 to 3 and the enzyme-untreated green tea extract in Comparative Example 1 which were diluted 5-fold with water, the organoleptic evaluation was performed by five expert panelists according to the following evaluation criteria. A numerical value in the following table was shown in terms of an average evaluation value.

Intensity of Aroma:

Re: Effect of enhancing aroma

1) No effect of enhancing aroma, i.e., similar to the untreated one.

2) Somewhat perceptive effect of enhancing aroma.

3) Clearly perceptive effect of enhancing aroma.

4) Remarkably perceptive effect of enhancing aroma.

Quality of Aroma:

Re: Tea-like quality

1) Much different from green tea.

2) Not so much like green tea.

3) Somewhat like green tea.

4) Similar to green tea.

The results are shown in Table 1.

TABLE 1

| | Intensity of aroma | Quality of aroma |
|---|---|---|
| Example 1 | 3.0 | 3.6 |
| Example 2 | 3.2 | 3.6 |
| Example 3 | 3.8 | 3.0 |
| Comparative | 1.0 | 1.8 |
| Example 1 | | |

Table 1 reveals that the green feel is enhanced in the green tea extract treated with the group of enzymes producing the green aroma compound and the intensity of aroma is increased without losing the aroma balance as green tea. The green tea extracts different in quality of aroma and intensity of aroma can be prepared by varying the treatment temperature.

### Example 4

An enzyme-treated green tea extract was obtained in the same manner as in Example 2 except that the enzyme treatment time was changed from 12 hours to 1 hour.

### Example 5

An enzyme-treated green tea extract was obtained in the same manner as in Example 2 except that the enzyme treatment time was changed from 12 hours to 24 hours.

### Example 6

An enzyme-treated green tea extract was obtained in the same manner as in Example 2 except that the enzyme treatment time was changed from 12 hours to 34 hours.

### Example 7

An enzyme-treated green tea extract was obtained in the same manner as in Example 2 except that the enzyme treatment time was changed from 12 hours to 42 hours.

### Comparative Example 2

An enzyme-untreated green tea extract was obtained in the same manner as in Example 5 except that 15 ml of a 2-mM phosphate buffer solution (pH 7.0) was added instead of the defatted soybean cake-treated solution.

Organoleptic Evaluation (2)

The organoleptic evaluation of aroma in Examples 4 to 7 and Comparative Example 2 was performed by five expert panelists in the same manner as the organoleptic evaluation (1). The results are shown in Table 2.

TABLE 2

| | Intensity of aroma | Quality of aroma |
|---|---|---|
| Example 4 | 3.0 | 3.4 |
| Example 5 | 3.6 | 3.8 |
| Example 6 | 3.8 | 3.8 |
| Example 7 | 3.8 | 3.6 |
| Comparative | 1.0 | 1.8 |
| Example 2 | | |

Table 2 reveals that the green feel is enhanced in the green tea extract treated with the group of enzymes producing the green aroma compound and the intensity of aroma is increased without losing the aroma balance as green tea. The green tea extracts different in quality of aroma and intensity of aroma can be prepared by varying the treatment time.

### Example 8

An enzyme-treated green tea extract was obtained in the same manner as in Example 6 except that the amount of ion-exchanged water was changed from 135 ml to 149.985 ml and the addition amount of the defatted soybean cake-treated solution was changed from 15 ml to 0.015 ml.

### Example 9

An enzyme-treated green tea extract was obtained in the same manner as in Example 6 except that the amount of ion-exchanged water was changed from 135 ml to 149.85 ml and the addition amount of the defatted soybean cake-treated solution was changed from 15 ml to 0.15 ml.

### Example 10

An enzyme-treated green tea extract was obtained in the same manner as in Example 6 except that the amount of ion-exchanged water was changed from 135 ml to 148.5 ml and the addition amount of the defatted soybean cake-treated solution was changed from 15 ml to 1.5 ml.

### Example 11

An enzyme-treated green tea extract was obtained in the same manner as in Example 6 except that the amount of ion-exchanged water was changed from 135 ml to 120 ml and the addition amount of the defatted soybean cake-treated solution was changed from 15 ml to 30 ml.

Organoleptic Evaluation (3)

The organoleptic evaluation of aroma in Examples 8 to 11 was performed by five expert panelists in the same manner as the organoleptic evaluation (1). The results are shown in Table 3.

TABLE 3

| | Intensity of aroma | Quality of aroma |
|---|---|---|
| Example 8 | 3.0 | 3.2 |
| Example 9 | 3.2 | 3.2 |
| Example 10 | 3.6 | 3.6 |
| Example 11 | 3.8 | 3.6 |

Table 3 reveals that the green feel is enhanced in the green tea extract treated with the group of enzymes producing the green aroma compound and the intensity of aroma is increased without losing the aroma balance as green tea. The green tea extracts different in quality of aroma and intensity of aroma can be prepared by varying the addition amount of the defatted soybean cake-treated solution.

### Comparative Example 3

### Preparation of a Tea Extract Treated with an Enzyme Producing a Floral Aroma Compound

To 14 g of green tea leaves pulverized with a cocking cutter, 140 ml of ion-exchanged water of 25° C. was added, and 70 mg (0.05% by mass) of β-glucosidase (manufactured by Sigma) was further added to conduct enzyme treatment in a thermostat at 50° C. for 3 hours. The tea leaves were then removed by filtration with a cloth. The resulting extract was heat-treated at 90° C. for 10 minutes to obtain a green tea extract treated with the enzyme producing the floral aroma compound.

### Examples 12 to 14

The green tea extract treated with the group of enzymes producing the green aroma compound as prepared in Example 6 and the green tea extract treated with the enzyme producing the floral aroma compound as prepared in Comparative Example 3 were mixed at the following ratio to obtain each enzyme-treated green tea extract.
Example 12 Example 6: Comparative Example 3=9:1 (mass ratio)
Example 13 Example 6: Comparative Example 3=5:5 (mass ratio)
Example 14 Example 6: Comparative Example 3=1:9 (mass ratio)
   Organoleptic Evaluation (4)

The organoleptic evaluation of aroma in Examples 12 to 14 and Comparative Example 3 was performed by five expert panelists in the same manner as the organoleptic evaluation (1). The results are shown in Table 4.

TABLE 4

| | Intensity of aroma | Quality of aroma |
|---|---|---|
| Example 12 | 3.8 | 4.0 |
| Example 13 | 4.0 | 3.8 |
| Example 14 | 4.0 | 3.8 |
| Comparative | 4.0 | 1.2 |
| Example 3 | | |

Table 4 reveals that the green feel is enhanced in the green tea extract treated with the group of enzymes producing the green aroma compound and the flavor is close to that of high-grade tea. Meanwhile, the floral feel is enhanced in the green tea extract treated with the enzyme producing the floral aroma compound, and the extract is, as a whole, a black tea-like extract rather than a green tea extract to greatly lose an aroma balance as green tea. However, the aroma balance is much improved by mixing the green tea extract treated with the group of enzymes producing the green aroma compound with the green tea extract treated with the enzyme producing the floral aroma compound.

That is, Examples 12 to 14 in which the green tea extracts treated with the respective groups of enzymes are mixed have provided the tea extracts in which the intensity of aroma is increased, the green tea-like quality is provided and the aroma balance is maintained.

The green tea extracts different in type of aroma can also be prepared by controlling the mixing ratio.

### Example 15

### Preparation of an Oolong Tea Extract Treated with an Enzyme Producing a Green Aroma Compound

To 15 g of oolong tea leaves (Chinese-grown, Shiki-syu, low-grade) pulverized with a cocking cutter, 135 ml of ion-exchanged water was added, and 15 ml of defatted soybean cake-treated solution obtained in Example 1 was further added to conduct enzyme treatment in a thermostat at 25° C. for 34 hours. The tea leaves were then removed by filtration with a cloth. The resulting extract was heat-treated at 90° C. for 10-minutes to obtain an oolong tea extract treated with the enzyme producing the green aroma compound.

### Comparative Example 4

An enzyme-untreated oolong tea extract was obtained in the same manner as in Example 15 except that 15 ml of a 20 mM phosphate buffer solution (pH 7.0) was added instead of the defatted soybean cake-treated solution.

### Comparative Example 5

### Preparation of an Oolong Tea Extract Treated with an Enzyme Producing a Floral Aroma Compound

To 14 g of oolong tea leaves pulverized with a cocking cutter, 140 ml of ion-exchanged water of 25° C. was added, and 70 mg (0.05% by mass) of β-glucosidase (manufactured by Sigma) was further added to conduct enzyme treatment in a thermostat at 50° C. for 3 hours. The tea leaves were then removed by filtration with a cloth. The resulting extract was heat-treated at 90° C. for 10 minutes to obtain an oolong tea extract treated with the enzyme producing the floral aroma compound.

### Example 16

The oolong tea extract treated with the group of enzymes producing the green aroma compound as prepared in Example 15 and the oolong tea extract treated with the enzyme producing the floral aroma compound as prepared in Comparative Example 5 were mixed at the ratio with Example 15: Comparative Example 5=5:5 (mass ratio) to obtain enzyme-treated oolong tea extract.

Organoleptic Evaluation (5)

With respect to the enzyme-treated oolong tea extracts in Examples 15 to 16 and Comparative Example 5 and the enzyme-untreated oolong tea extract in Comparative Example 4 which were diluted 5-fold with water, the organoleptic evaluation was performed by five expert panelists according to the following evaluation criteria. A numerical value in the following table was shown in terms of an average evaluation value.

Intensity of Aroma:

Re: Effect of enhancing aroma

1) No effect of enhancing aroma, i.e., similar to the untreated one.

2) Somewhat perceptive effect of enhancing aroma.

3) Clearly perceptive effect of enhancing aroma.

4) Remarkably perceptive effect of enhancing aroma.

Quality of Aroma:

Re: Tea-like quality

1) Much different from oolong tea.

2) Not so much like oolong tea.

3) Somewhat like oolong tea.

4) Similar to oolong tea.

The results are shown in Table 5.

TABLE 5

| | Intensity of aroma | Quality of aroma |
|---|---|---|
| Example 15 | 3.8 | 3.8 |
| Example 16 | 4.0 | 4.0 |
| Comparative | 1.0 | 1.8 |
| Example 4 | | |
| Comparative | 4.0 | 1.6 |
| Example 5 | | |

Table 5 reveals that the green feel is enhanced in the oolong tea extract treated with the group of enzymes producing the green aroma compound and the freshness is expressed. Meanwhile, in the oolong tea extract treated with the enzyme producing the floral aroma compound, the floral feel is enhanced and the aroma is slightly heavy. However, the aroma balance is improved and the aroma becomes natural by mixing the oolong tea extract treated with the group of enzymes producing the green aroma compound with the oolong tea extract treated with the enzyme producing the floral aroma compound.

That is, Examples 16 in which the oolong tea extracts treated with the respective groups of enzymes are mixed have provided the tea extracts in which the intensity of aroma is increased, the oolong tea-like quality is provided and the aroma balance is maintained.

The oolong tea-extracts different in type of aroma can also be prepared by controlling the mixing ratio.

### Example 17

### Preparation of a Black Tea Extract Treated with an Enzyme Producing a Green Aroma Compound

To 15 g of black tea leaves (Ceyron, low-grade) pulverized with a cocking cutter, 135 ml of ion-exchanged water was added, and 15 ml of defatted soybean cake-treated solution obtained in Example 1 was further added to conduct enzyme treatment in a thermostat at 25° C. for 34 hours. The tea leaves were then removed by filtration with a cloth. The resulting extract was heat-treated at 90° C. for 10 minutes to obtain a black tea extract treated with the enzyme producing the green aroma compound.

### Comparative Example 6

An enzyme-untreated black tea extract was obtained in the same manner as in Example 17 except that 15 ml of a 20 mM phosphate buffer solution (pH 7.0) was added instead of the defatted soybean cake-treated solution.

### Comparative Example 7

### Preparation of a Black Tea Extract Treated with an Enzyme Producing a Floral Aroma Compound

To 14 g of black tea leaves pulverized with a cocking cutter, 140 ml of ion-exchanged water of 25° C. was added, and 70 mg (0.05% by mass) of β-glucosidase (manufactured by Sigma) was further added to conduct enzyme treatment in a thermostat at 50° C. for 3 hours. The tea leaves were then removed by filtration with a cloth. The resulting extract was heat-treated at 90° C. for 10 minutes to obtain a black tea extract treated with the enzyme producing the floral aroma compound.

### Example 18

The black tea extract treated with the group of enzymes producing the green aroma compound as prepared in Example 17 and the black tea extract treated with the enzyme producing the floral aroma compound as prepared in Comparative Example 7 were mixed at the ratio with Example 17: Comparative Example 7=5:5 (mass ratio) to obtain enzyme-treated black tea extract.

Organoleptic Evaluation (6)

With respect to the enzyme-treated black tea extracts in Examples 17 to 18 and Comparative Example 7 and the enzyme-untreated black tea extract in Comparative Example 6 which were diluted 5-fold with water, the organoleptic evaluation was performed by five expert panelists according to the following evaluation criteria. A numerical value in the following table was shown in terms of an average evaluation value.

Intensity of Aroma:

Re: Effect of enhancing aroma

1) No effect of enhancing aroma, i.e., similar to the untreated one.

2) Somewhat perceptive effect of enhancing aroma.

3) Clearly perceptive effect of enhancing aroma.

4) Remarkably perceptive effect of enhancing aroma.

Quality of Aroma:

Re: Tea-like quality

1) Much different from black tea.

2) Not so much like black tea.

3) Somewhat like black tea.

4) Similar to black tea.

The results are shown in Table 6.

TABLE 6

| | Intensity of aroma | Quality of aroma |
|---|---|---|
| Example 17 | 3.8 | 3.8 |
| Example 18 | 4.0 | 4.0 |
| Comparative | 1.0 | 1.8 |
| Example 6 | | |
| Comparative | 4.0 | 1.8 |
| Example 7 | | |

Table 6 reveals that the green feel is enhanced in the black tea extract treated with the group of enzymes producing the green aroma compound and the freshness is expressed. Meanwhile, in the black tea extract treated with the enzyme producing the floral aroma compound, the floral feel is enhanced and the aroma is slightly heavy. However, the aroma balance is improved and the aroma becomes natural by mixing the black tea extract treated with the group of enzymes producing the green aroma compound with the black tea extract treated with the enzyme producing the floral aroma compound.

That is, Examples 18 in which the black tea extracts treated with the respective groups of enzymes are mixed have provided the tea extracts in which the intensity of aroma is increased, the black tea-like quality is provided and the aroma balance is maintained.

The black tea extracts different in type of aroma can also be prepared by controlling the mixing ratio.

### Example 19

### Preparation of an Enzyme-Treated Natural Green Tea Aroma from a Green Tea Extract Treated with a Group of Enzymes Producing a Green Aroma Compound Using SCC

While adding water, 120 kg of green tea leaves was pulverized with a grinder (masukoroyder™), and 108 kg of the defatted soybean cake-treated solution in Example 1 was added to prepare a slurry having an overall concentration of 10% (w/w). While stirring the slurry in an extraction tank, enzyme treatment was conducted at 25° C. for 36 hours. The slurry was cooled, filtered, then fed to SCC, and collected under the following operation conditions to obtain a natural green tea aroma treated with the group of enzymes producing the green aroma compound and an enzyme-treated green tea extract residue. The enzyme-treated green tea extract residue was further subjected to Celite filtration to obtain a clear enzyme-treated green tea extract.

SCC Operation Conditions:
Raw material feed rate: 700 L/h
Column temperature: 100° C.
Strip ratio: 2%

### Comparative Example 8

### Preparation of an Enzyme-Treated Natural Green Tea Aroma from a Green Tea Extract Treated with an Enzyme Producing a Floral Aroma Compound Using SCC

While adding water, 120 kg of green tea leaves was pulverized with a grinder (masukoroyder™) to prepare a slurry having a concentration of 10% (w/w). 600 g of β-glucosidase was added, and enzyme treatment was conducted at 50° C. for 3 hours while stirring in an extraction tank. The slurry was cooled, filtered, then fed to SCC, and collected under the same operation conditions as in Example 19 to obtain a natural green tea aroma treated with the enzyme producing the floral aroma compound and an enzyme-treated green tea extract residue. The enzyme-treated green tea extract residue was further subjected to Celite filtration to obtain a clear enzyme-treated green tea extract.

### Comparative Example 9

### Preparation of a Green Tea Aroma from an Enzyme-Untreated Tea Extract Using SCC

While adding water, 120 kg of green tea leaves was pulverized with a grinder (masukoroyder™) to prepare a slurry having a concentration of 10% (w/w). After filtration, the filtrate was fed to SCC, and collected under the same operation conditions as in Example 19 to obtain a green tea aroma and a green tea extract residue untreated with an enzyme. The green tea extract residue was further subjected to Celite filtration to obtain a clear green tea extract.

### Examples 20 to 22

The natural green tea aroma treated with the group of enzymes producing the green aroma compound as prepared in Example 19 and the green tea aroma treated with the enzyme producing the floral aroma compound as prepared in Comparative Example 8 were mixed at the following ratio to obtain an enzyme-treated natural green tea aroma.
Example 20 Example 19: Comparative Example 8=9:1 (mass ratio)
Example 21 Example 19: Comparative Example 8=5:5 (mass ratio)
Example 22 Example 19: Comparative Example 8=1:9 (mass ratio)

### Comparative Example 10

High-grade tea leaves (trade name: Yame Okumidori (manufactured by Gonoe Seicha) was extracted (70° C., 3 minutes) with hot water in an amount of 50 times of that of the tea leaves to obtain a high-grade green tea extract.

Organoleptic Evaluation (7)

Each treated green tea aroma was applied to a green tea extract obtained by extracting tea leaves (low-grade product) with hot water in an amount of 50 times of that of the tea leaves (70° C., 3 minutes) at a used level of 0.02%. Regarding each of the resulting products, the organoleptic evaluation was performed by five expert panelists according to the following evaluation criteria. At the same time, Comparative Example 10 was also evaluated. A numerical value in the table was shown in terms of an average evaluation value.

Intensity of Aroma:

Re: Effect of enhancing aroma

1) No effect of enhancing aroma, i.e., similar to the untreated one.

2) Somewhat perceptive effect of enhancing aroma.

3) Clearly perceptive effect of enhancing aroma.

4) Remarkably perceptive effect of enhancing aroma.

Quality of Aroma:

Re: Tea-like quality

1) Much different from green tea.

2) Not so much like green tea.

3) Somewhat like green tea.

4) Similar to green tea.

The organoleptic evaluation of aroma in Examples 19 to 22 and Comparative Examples 8 to 10 was performed by five expert panelists. The results are shown in Table 7.

TABLE 7

| | Intensity of aroma | Quality of aroma |
|---|---|---|
| Example 19 | 3.8 | 3.8 |
| Example 20 | 4.0 | 4.0 |
| Example 21 | 4.0 | 4.0 |
| Example 22 | 4.0 | 3.8 |
| Comparative | 4.0 | 1.4 |
| Example 8 | | |
| Comparative | 2.0 | 2.0 |
| Example 9 | | |
| Comparative | 4.0 | 4.0 |
| Example 10 | | |

The results in Table 7 reveal that when aroma is imparted to the natural green tea aroma treated with the group of enzymes producing the green aroma compound, the green feel is enhanced, and the product is close to a flavor of high-grade tea.

Meanwhile, when aroma is imparted to the natural green tea aroma treated with the enzyme producing the floral aroma compound, the floral feel is somewhat too strong, and the product gives slightly a strange feel as green tea.

However, in Examples 20 to 22 wherein the natural green tea aroma treated with each group of enzymes is incorporated, an intensity of aroma is increased, a green tea-like property is provided and the aroma balance is maintained.

In addition, enzyme-treated natural green tea aroma different in type of aroma can also be prepared by controlling the mixing ratio.

### Example 23

### Preparation of an Enzyme-Treated Natural Green Tea Aroma Concentrated Extract

The enzyme-treated natural green tea aroma obtained in Example 21 by mixing the natural green tea aroma treated with the group of enzymes producing the green aroma compound and the natural green tea aroma treated with the enzyme producing the floral aroma compound at a ratio of 5:5 was mixed with the clear green tea extract obtained in Example 19 at 1:10 (mass ratio) to obtain an enzyme-treated natural green tea aroma concentrated extract.

### Example 24

### Preparation of an Enzyme-Treated Natural Green Tea Aroma from a Green Tea Extract Treated with a Group of Enzymes Producing a Green Aroma Compound Using an Extraction Method with Carbon Dioxide in a Liquid State or a Supercritical State

While adding water, 20 kg of green tea leaves was pulverized with a grinder (masukoroyder™), and 18 kg of the defatted soybean cake-treated solution in Example 1 was added to prepare a slurry having an overall concentration of 10% (w/w). The slurry was put in an extraction vessel with a content of 60% and extraction was conducted by introducing carbon dioxide in a supercritical state with the following operation conditions. Thereafter, an enzyme-treated green tea natural aroma was obtained by absorbing the same in 50% (w/w) water-containing ethanol in an amount of 5% of the preparation amount for the collection thereof.

Operation Conditions:
Extraction vessel temperature: 40° C.
Separation vessel temperature: 40° C.
Extraction vessel pressure: 300 kgf/cm²
Separation vessel pressure: 50 kgf/cm²

While the invention has been described in detail and with reference to specific embodiments thereof, it will be apparent to one skilled in the art that various changes and modifications can be made therein without departing from the scope thereof.

This application is based on Japanese patent application No. 2004-354967 filed Dec. 8, 2004, the entire contents thereof being hereby incorporated by reference.

### INDUSTRIAL APPLICABILITY

The tea leaves, the tea extract or the tea slurry is reacted with the enzyme and/or the group of enzymes producing the green aroma compound as an important aroma compound of tea aroma, and the enzyme-treated tea extract is subjected to the means of collecting aroma such as a gas-liquid countercurrent contact extraction method or an extraction method with carbon dioxide in a liquid state or a supercritical state to collect aroma, whereby the enzyme-treated natural tea aroma and the enzyme-treated natural tea aroma concentrated extract excellent in balance of tea aroma can be obtained at low cost. The flavor composition containing the thus-obtained enzyme-treated tea extract, enzyme-treated natural tea aroma or enzyme-treated natural tea aroma concentrated extract can be used in food and drink. Even though less costly tea leaves are used as the raw materials, the enzyme-treated tea extract, the enzyme-treated natural tea aroma and the enzyme-treated natural tea aroma concentrated extract having aroma of high-grade tea and enhanced aroma can be provided safely and eco-friendly.

1: A process for producing an enzyme-treated tea extract, which comprises allowing at least one selected from an enzyme and/or a group of enzymes capable of producing a green aroma compound to act on a tea extract, a tea slurry and/or a tea leaf.

2: The process for producing an enzyme-treated tea extract according to claim 1, wherein the enzyme and/or the group of enzymes capable of producing the green aroma compound is crude enzymes derived from soybean.

3: A process for producing an enzyme-treated natural tea aroma and an enzyme-treated natural tea aroma concentrated extract, which comprises collecting a tea aroma from the enzyme-treated tea extract obtainable by the process according to claim 1 or 2.

4: The process for producing an enzyme-treated natural tea aroma and an enzyme-treated natural tea aroma concentrated extract according to claim 3, wherein the tea aroma is collected by a gas-liquid countercurrent contact extraction method or an extraction method with carbon dioxide in a liquid state or a supercritical state.

5: An enzyme-treated tea extract which is produced by the process according to claim 1 or 2.

6: An enzyme-treated natural tea aroma which is produced by the process according to claim 3.

7: An enzyme-treated natural tea aroma concentrated extract which is produced by the process according to claim 3.

8: A food or drink comprising the enzyme-treated tea extract according to claim 5.

9: A food or drink comprising the enzyme-treated natural tea aroma according to claim 6.

10: A food or drink comprising the enzyme-treated natural tea aroma concentrated extract according to claim 7.
